(19) United States
(12) Patent Application Publication
(10) Pub. No.: US 2006/0143055 A1
(43) Pub. Date: Jun. 29, 2006

(54) Method for increasing liquid assets available to at least partially fund living expenses at an assisted living facility

(76) Inventors: Philip R. Loy, Canton, GA (US); Ron L. Kreiter, Danville, KY (US)

Correspondence Address: KEVIN P. CROSBY;BRINKLEY MCNERNEY MORGAN SOLOMAN & TATUM LLP, 200 E. LAS OLAS BLVD, SUITE 1900, FORT LAUDERDALE, FL, 33301, US

(21) Appl. No.: 11/022,584

(22) Filed: Dec. 23, 2004

(51) Int. Cl. G06Q 40/00

(52) U.S. Cl. 705/4; 705/35

(57) ABSTRACT

A method for increasing liquid assets available to an individual to at least partially find living expenses of the individual at an assisted living facility includes consulting with the individual to identify whether the individual owns a life insurance policy and, if he or she does, advising the individual as to the availability of selling the policy to obtain funds for paying the individual's assisted living expenses, thereby temporarily deferring the individual's dependence on governmental assistance for such living expenses. To insure that the sales proceeds are used to pay the assisted living expenses of the individual, the proceeds are preferably paid into a trust for the benefit of the individual. In the event that the individual dies before exhausting the sales proceeds, such proceeds may be used to pay the individual's funeral expenses or may be distributed to one or more heirs of the deceased.

### BACKGROUND OF THE INVENTION

1. Field of the Invention

The present invention relates generally to the funding of living expenses for individuals considering relocation to a nursing home, assisted living center, hospital, long term care facility or any other assisted living facility and, in particular, to a method for increasing liquid assets of such individuals for use in paying at least some of the living expenses incurred at assisted living facilities through sale of the individuals' life insurance policies.

2. Current Relevant Art

Life insurance has been a valued product for many years. Individuals, relatives and corporations have purchased life insurance to protect themselves, their families and, in the case of officers and directors, their businesses from, inter alia, sudden loss of income. However, as a wage earner becomes older, the need to protect the family from sudden loss of the wage earner decreases or is eliminated. Alternatively, in the case of a corporation, the officer or director on whose life a life insurance policy was issued may have retired or otherwise left the corporation, and the corporation no longer has a need for the policy.

In the past, the options for an elderly insured was to allow the policy to lapse or, in the case of life insurance policies that were not paid up over time, continue to pay the premiums, which in some cases are rather large, if coverage was still desired for some reason. However, new needs typically arise for the insured and his or her family as the insured grows older. For example, medical needs of terminally or chronically ill individuals may require a large outlay of cash or other liquid assets to pay for services that are not covered by the individual's health insurance, Medicare, or Medicaid. In some cases, such individuals are best served by entering a nursing home or other assisted living facility where they can receive necessary, professional care on a regular basis.

When a terminally or chronically ill person, age 65 or older, desires to enter a nursing home or other assisted living facility and further desires to use Medicaid to fund the person's stay and care, state Medicaid regulations generally require the person to divest himself or herself of substantially all liquid and liquidatable assets, subject to state-specific exemptions. Such regulations typically permit the person to retain a small amount of liquid or liquidatable assets. For example, states generally limit the face value of life insurance of an assisted living, Medicaid recipient to an amount of one thousand five hundred dollars ($1,500.00) or less. Thus, in many cases, a considerable amount of a person's life insurance is vulnerable to divestment in order to receive Medicaid funding of assisted living expenses.

Several methods presently exist to enable a Medicaid applicant to divest himself or herself of life insurance owned by the applicant. First, the applicant can simply cash in his or her policy for whatever cash value is in the policy. However, the cash value is often very small when compared to the costs of funding assisted living services and does not generally afford the Medicaid applicant sufficient funds to pay for living expenses associated with residing at a nursing home, an assisted living center, a long term care facility, or any other assisted living facility. Moreover, due to the substantial nature of the costs associated with providing assisted living services, the cash value of the applicant's life insurance policy is typically incapable of providing any significant delay in connection with the need for Medicaid or other governmental assistance funds.

More recently, insurance companies have afforded the owner of a life insurance policy the opportunity to transfer any cash value or accelerated death benefit the owner has in the life insurance policy into a limited long term care policy at the time the owner enters a nursing home or other assisted living facility. While the popularity of accelerated death benefits is slowly evolving, such benefits are most often available only for policies in which the owner is the insured and only when either the life expectancy of the insured is twelve months or less or the insured's illness, disease, or condition falls within certain specified categories.

As a third option, the owner of the life insurance policy may present the policy to a viatical or life settlement provider in an effort to obtain cash for the policy. Viatical settlements are liquation vehicles for life insurance policies in which a viatical settlement provider determines a life expectancy of the insured based on a variety of factors, including the medical history of the insured, and, based on the life expectancy and the face value of the policy, offers the owner of the policy a percentage of the face value of the policy, less any outstanding loans or presently due premiums. The proceeds to fund the offer are acquired from investors (e.g., institutional or individual investors). Presently, the amount of a viatical settlement offer is largely unregulated, although the cash payment made to the policy owner is required to be more than the cash value or accelerated death benefit, if any, of the policy. Some states specify the percentages that must be paid to the policy owner if the insured has a life expectancy of twenty four (24) months or less. Such specified percentages are typically eighty percent (80%) if the insured's life expectancy is less than six months, seventy percent (70%) if the insured's life expectancy is at least six months, but less than twelve months, sixty-five percent (65%) if the insured's life expectancy is at least twelve months, but less than eighteen months, and sixty percent (60%) if the insured's life expectancy is at least eighteen months, but less than twenty-four months. In exchange for the viatical settlement, the policy owner assigns or otherwise transfers his or her ownership of the life insurance policy to the viatical settlement provider, which in turn transfers the policy to the particular investor. The viatical settlement proceeds are generally held by an escrow agent until the policy owner has transferred the policy to the viatical settlement provider, at which time the proceeds are disbursed by the escrow agent to the ex-policy owner or his designee (e.g., an attorney or a guardian).

While the foregoing methods for liquidating some or all of the face value of a life insurance policy are presently available to the policy owner, none of the methods require or insure that the proceeds received by the policy owner are used to pay the living expenses of the policy owner while the policy owner resides at an assisted living facility. Since the policy owner or its designee has no obligation to use the liquidated or divested proceeds to find assisted living expenses, state and federal assistance programs, such as Medicaid, often do not reap any benefit of the program applicant's divestiture of life insurance policies. In addition, there is presently no procedure for advising an individual or his guardian as to the individual's various options for divesting of life insurance policies owned by the individual to increase the assets used by the individual to pay assisted living expenses and, thereby, temporarily defer the individual's reliance on government assistance.

U.S. Patent Application Publication No. US 2004/0225537 (“the '537 Publication”) discloses a method for raising funds for non-profit organizations using life insurance policies. Pursuant to the disclosed method, a non-profit organization (“NPO”) identifies individuals or groups of individuals in whom the NPO has a potential insurable interest. The NPO then requests authorization from the individuals to take out life insurance policies on the lives of the individuals pursuant to the NPO's insurable interests. Upon receiving authorization from the individuals, the NPO takes out one or more life insurance policies covering the insurable interests naming the NPO as beneficiary. The NPO may also group the life insurance policies and sell the policies to raise funds for the NPO. The NPO utilizes a “passive vehicle” to hold the insurance policies so that the passive vehicle is “bankruptcy remote.” Therefore, while providing a means for finding an NPO, the method disclosed in the '537 Publication provides no benefit to an individual seeking finding for assisted living expenses.

U.S. Patent Application Publication No. US 2004/0148202 (“the '202 Publication”) discloses a system in which an insurance policy is purchased from an insured and replaced with a substitute policy at a lower face value and premium. The replaced policy may or may not be maintained long term depending upon, inter alia, a life expectancy of the insured. While providing a means for an aging individual to maintain at least some form of life insurance instead of having to allow the original policy to simply expire due to the individual's inability to continue making premium payments, the '202 Publication provides no mechanism through which the individual may increase his or her liquid assets for purposes of funding assisted living expenses.

U.S. Pat. No. 5,926,800 (“the '800 Patent”) discloses a system for providing loans to owners of life insurance policies where the owner retains ownership of the polices during his or her lifetime, and the insured obtains a line of credit upon terms determined by an algorithm used by the system. Therefore, while providing one mechanism for extracting cash from a life insurance policy, the '800 Patent does not disclose or suggest any means for delaying or deferring the individual's reliance upon government assistance. Rather, the loan approach disclosed in the '800 Patent would potentially permit the policy owner to extract proceeds from a life insurance policy and simultaneously qualify for Medicaid, thereby increasing the governmental assistance burden.

U.S. Patent Application Publication No. US 2001/0047325 A1 (“the '325 Publication”) discloses a method for providing lines of credit or loans to terminally ill and health-compromised individuals who have a qualified life insurance policy. The loans are secured by the policy. Upon death, the company collects the benefits of the life insurance policy, pays off the loan and any premiums advanced by the lender plus origination fees and accrued interest, and gives the remaining funds to the beneficiary designated by the borrower. Therefore, similar to the '800 Patent, the '325 Publication does not disclose or suggest any means for lightening the government's burden of providing funds for assisted living expenses of terminally ill individuals.

U.S. Pat. No. 6,393,405 (“the '405 Patent”) discloses a method of calculating payout ratios in a transaction in which a chronically ill individual sells a portion of his or her life insurance proceeds in exchange for an investor paying the premiums. The policy remains owned by the individual, but the death benefit to the individual's own beneficiaries decreases the longer the investor pays the premiums. However, the '405 Patent does not disclose or suggest any means for liquidating the life insurance policy for purposes of funding the assisted living expenses of the individual, thereby delaying the individual's dependence on governmental assistance.

Finally, U.S. Pat. No. 6,330,541 (“the '541 Patent”) discloses a system and method of managing a pool of life insurance policies to generate a consistent cash flow from death benefits paid on the insurance polices so that at least a portion of the cash flow may be sold to a third party. While providing a mechanism for administratively managing a pool of life insurance policies, the '541 Patent provides no means for increasing the liquid assets of an individual to meet at least some of the assisted living expenses of the individual.

Therefore, a need exists for a method of increasing liquid assets available to an individual (e.g., an owner of a life insurance policy) to at least partially fund living expenses of the individual at an assisted living facility that provides a mechanism for advising the individual as to the availability of selling the individual's life insurance policy and that insures proceeds of any such sale are indeed used to pay the assisted living expenses of the individual, thereby delaying, if even for a short period, the individual's dependence upon government assistance.

### SUMMARY OF THE INVENTION

Therefore, it is one object of the present invention to provide a method for increasing liquid assets available to an individual to at least partially fund living expenses (including medical and other healthcare expenses) of the individual at an assisted living facility.

It is a further object of the present invention to provide a method in which an entity, such as the assisted living facility, advises the individual as to the availability of selling a life insurance policy owned by the individual and may further advise the individual as to the availability and requirements for obtaining government assistance (e.g., through Medicare and/or Medicaid) to fund the individual's assisted living expenses if the individual meets pre-established criteria for obtaining such assistance. Such criteria may include divestiture of substantially all the liquid and liquidatable assets owned by the individual.

It is a further object of the present invention to provide a means for individuals to remain private pay patients at assisted living facilities for as long as possible, thereby deferring the individuals' dependence on governmental assistance and decreasing the pressure on governmental budgets to subsidize the living expenses of such individuals.

To solve the problems described above and to realize the objects of this invention, the present invention encompasses a method for increasing liquid assets available to an individual to at least partially fund living expenses of the individual at an assisted living facility, wherein an entity, such as the assisted living facility (e.g., through an admissions or other representative thereof), consults with the individual to determine what assets are available to the individual to pay for the assisted living facility's services. If the individual's assets include ownership of a life insurance policy, the entity advises the individual as to the ability of the individual to convert the policy into a liquid asset (e.g., cash) through sale of the policy. If, after being apprised of the option to sell the life insurance policy, the individual elects to proceed with such a sale, the entity advises the individual as to the identity of (e.g., refers the individual to) a potential purchaser, such as, for example, a viatical settlement provider, a financial institution, a governmental agency, a broker that acts as a representative of the viatical settlement provider or financial institution, or any other person or entity permitted under applicable law to purchase a life insurance policy. To facilitate the individual's sale of the life insurance policy, the entity may receive information related to the life insurance policy and/or the medical history or physical condition of the person insured by the life insurance policy (which may or may not be the individual in need of assisted living care), and provide such information to the potential purchaser after receiving written authorization from the individual or the insured, as applicable. The assisted living facility preferably receives payment for its services from the individual out of at least a portion of the proceeds received by the individual as a result of the sale of the life insurance policy.

To insure that the sales proceeds are indeed used to pay the assisted living expenses of the individual, the proceeds are preferably paid into a trust for the benefit of the individual. The trustee then pays the assisted living facility for the services provided to the individual (e.g., on a monthly or weekly basis). In the event that the individual dies before exhausting the sales proceeds, such proceeds may be used to pay the individual's funeral expenses or may be distributed to one or more heirs of the individual.

As used herein and in the appended claims, the term “assisted living facility” shall mean a nursing home, a hospital, a hospice care center, an assisted living center, a long term care facility, or any other facility at which an individual permanently or temporarily resides and receives healthcare or other general living assistance on a regular or continual basis by care providers (e.g., nurses, nurses' aides, volunteers, technicians, therapists, and doctors) employed by or otherwise associated with the facility. The term “assisted living facility” shall further mean any and all employees, representatives, or contractors of such facility or any entity controlled by, under common control with, controlling, affiliated with, or under contract with such facility.

As used herein and in the appended claims, the term “individual” shall mean, as applicable, a living person (e.g., a terminally ill person, a chronically ill person, a physically or mentally disabled person, or an elderly person), a guardian for such person, a family member related to such person, an attorney for such person, or any other person or entity to whom or which (a) the individual has given the authority to make medical or financial decisions on his or her behalf, or (b) authority has been given by court order or operation of law to make medical or financial decisions on behalf of the individual. For example, in connection with any activities of the individual other than directly receiving services from the assisted living facility, the term “individual” refers to any of the foregoing people or entities. On the other hand, in connection with services provided directly to a person by the assisted living facility, the term “individual” refers only to such person.

### BRIEF DESCRIPTION OF THE DRAWINGS

FIG. 1 is a block diagram of a system for increasing liquid assets available to an individual to at least partially fund living expenses of the individual at an assisted living facility in accordance with the present invention.

FIG. 2 is a flow diagram of steps executed by an assisted living facility to increase liquid assets of an individual to at least partially fund living expenses of the individual at the assisted living facility in accordance with the present invention.

FIG. 3 is a flow diagram of steps executed by a potential purchaser to increase liquid assets of an individual to at least partially find living expenses of the individual at an assisted living facility in accordance with the present invention.

FIG. 4 is a flow diagram of steps executed by an individual to increase his or her liquid assets to at least partially fund his or her living expenses at an assisted living facility in accordance with the present invention.

FIG. 5 is a flow diagram of steps executed by a trust to acquire and use liquid assets of an individual to at least partially fund living expenses of the individual at an assisted living facility in accordance with the present invention.

### DETAILED DESCRIPTION OF A PREFERRED EMBODIMENT

Generally, the present invention encompasses a method for increasing liquid assets available to an individual to at least partially fund the individual's living expenses (including the individual's medical and healthcare-related expenses) at an assisted living facility. Preferably, during a consultation between the individual and the assisted living facility (e.g., a facility admissions employee or other representative) prior to admission of the individual to the facility, the facility inquires as to how the individual will be paying for the facility's services. Such inquiry preferably identifies all the liquid and liquidatable assets of the individual to determine whether the individual will be a private pay patient or a government assisted patient. If such an inquiry results in identification of a life insurance policy owned by the individual, the assisted living facility advises or informs the individual as to the availability of selling the life insurance policy to liquidate the life insurance policy for purposes of funding the individual's living expenses. The assisted living facility also preferably advises the individual as to the applicable requirements for obtaining government assistance (e.g., Medicaid), which requirements typically require the individual to divest himself or herself from substantially all his or her liquid or liquidatable assets. If the individual elects to proceed with selling the life insurance policy (e.g., decides to viate the policy), the assisted living facility either advises the individual as to the identity of a potential purchaser (e.g., a viatical settlement provider or a financial institution) or obtains information from the individual related to the life insurance policy (e.g., a copy of the policy) and the physical condition of the insured (e.g., medical history, present diagnosis, and a medical release), and, after receiving written authorization from the individual and/or the insured, as applicable, provides the documents and information to an agent or representative for the potential purchaser.

After obtaining the life insurance policy information and the information relating to the physical condition of the insured (who may or may not be the individual seeking admission to the assisted living facility), the potential purchaser determines whether to purchase the policy based on the received information and preferably other information, such as medical records of the insured. If the potential purchaser decides to purchase the policy (e.g., in the case of viatical settlement, the viatical settlement provider has found or can likely find an investor that will pay a percentage of the face value of the policy in exchange for ownership of the policy), the potential purchaser provides a purchase offer to the individual.

If the individual accepts the offer, the purchaser provides the agreed upon funds directly or indirectly to the individual in exchange for ownership transfer of the life insurance policy to the purchaser or an investor acquiring ownership of the policy through the purchaser. In a preferred embodiment, the purchaser provides the agreed upon funds to an escrow agent. The escrow agent holds the funds until ownership of the life insurance policy has been transferred to the purchaser or the investor, at which time the funds are released to the individual or, more preferably, to a trust established to pay the living expenses of the individual while the individual resides at the assisted living facility. Ultimately, the assisted living facility receives some or all of the proceeds of the policy's sale as consideration for services provided to the individual. If the individual dies before exhausting the sales proceeds, the remaining funds may be used to pay the individual's funeral expenses or may be distributed to one or more heirs of the deceased.

By increasing the liquid assets of an individual in need of assisted living services in this manner, the present invention at least temporarily delays or defers the individual's reliance upon government assistance to pay the individual's assisted living expenses. In contrast to providing a loan or a line of credit to the individual that is secured by a life insurance policy owned by the individual as in the prior art, the present invention requires ownership of the policy to be transferred to a purchaser or an investor obtaining ownership of the policy through the purchaser. Thus, pursuant to the present invention, the funds received by the individual as a result of his or her life insurance policy increases the liquid assets of the individual that are available to pay the individual's assisted living expenses and are considered by the government when determining the individual's qualifications for receiving governmental assistance. Such an approach is in sharp contrast to prior art loan approaches, which provide no increase in worth because the cash received by the policy owner is offset by the indebtedness of the loan. Deferral of individuals' reliance on government assistance can have a substantial, positive impact on state and federal budgets by reducing the overall cost of government-assisted healthcare.

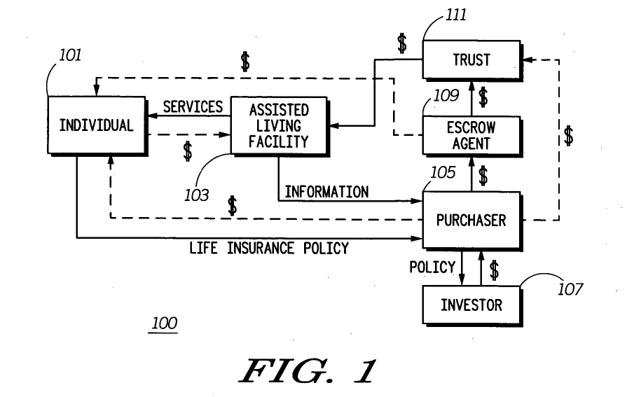

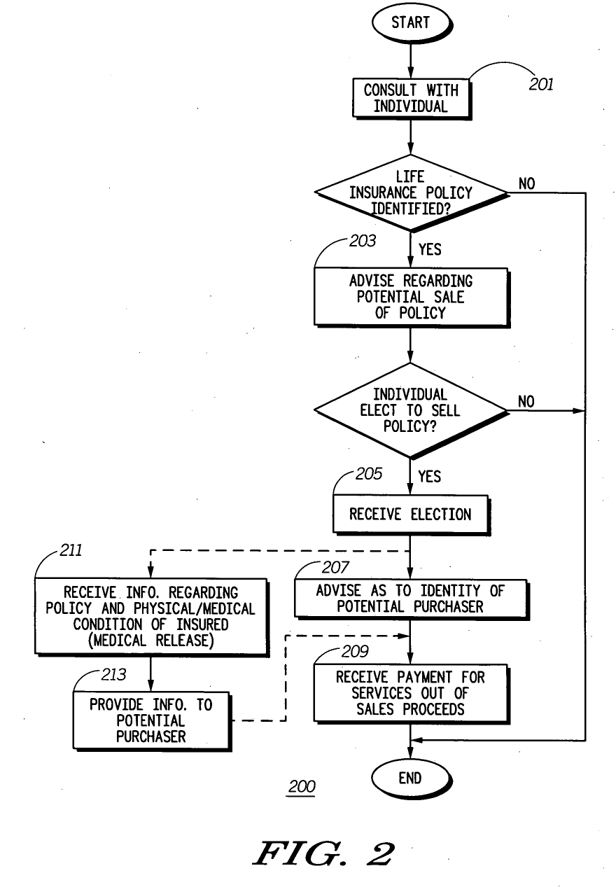

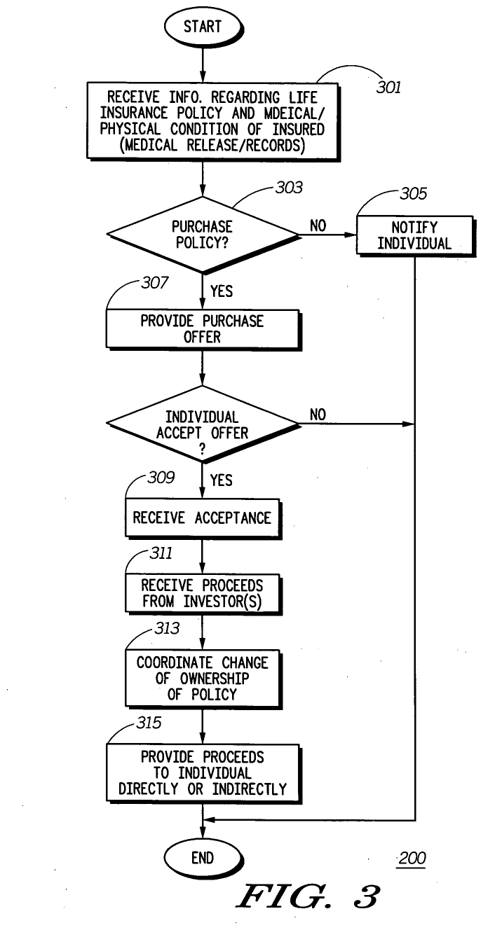

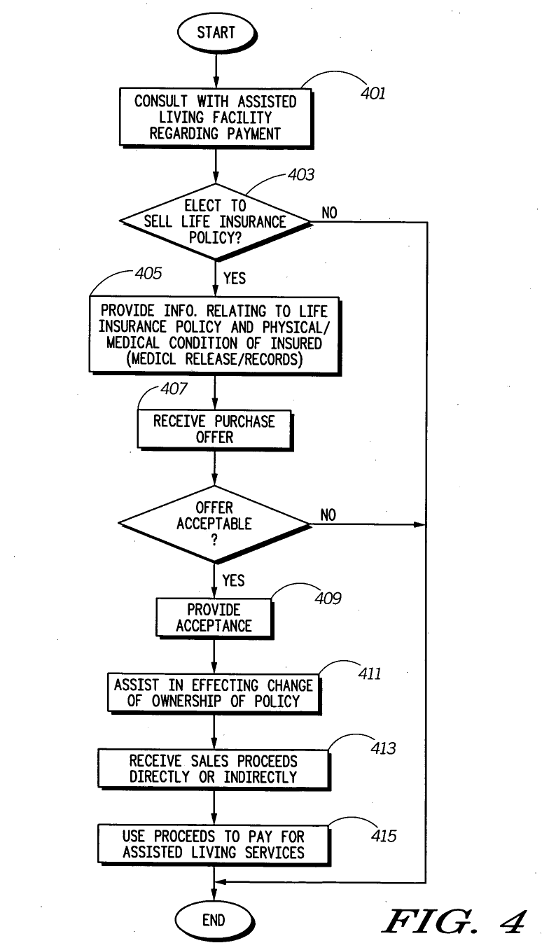

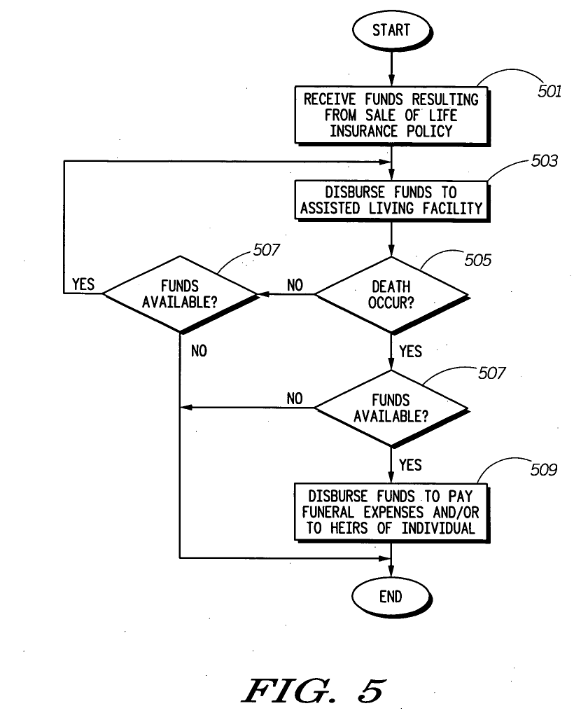

The present invention can be more fully understood with reference to FIGS. 1-5, in which like reference numerals designate like items. FIG. 1 is a block diagram of a system 100 for increasing the liquid assets of an individual 101 preferably for use in paying at least some of the assisted living expenses of the individual while the individual resides an assisted living facility 103. The system 100 includes at least the assisted living facility 103 and a purchaser 105. In the preferred embodiment, the system 100 further includes at least one investor 107 (e.g., an individual investor or an institutional investor), an escrow agent 109, and a trust 111. In one embodiment, the assisted living facility 103 may also serve as the purchaser 105, the investor 107, the escrow agent 109, and/or the trustee of the trust 111.. In another embodiment, the purchaser 105 may also serve as the investor 107, the escrow agent 109, and/or the trustee of the trust 111. In yet another embodiment, the escrow agent 109 may further serve as the trustee of the trust 111. However, in the preferred embodiment, the assisted living facility 103, the purchaser 105, the investor 107, the escrow agent, and the trust 111 are all independent entities.

In the preferred embodiment, the purchaser 105 is a licensed life or viatical settlement company or a financial institution. Alternatively, the purchaser 105 may be a governmental agency or any other person or entity permitted under applicable law to purchase life insurance policies. The escrow agent 109 is preferably a financial institution, an attorney or law firm, an insurance company, or a certified public accountant. Finally, the trustee of the trust 111 is preferably a financial institution, an insurance company, or an attorney.

Operation of the system 100 and execution of the various methods practiced by the system participants 101, 103, 105, 107, 109, 111 occur substantially as follows in accordance with the present invention. Prior to or at the time of admission of an individual to an assisted living facility 103, the facility representative consults (201, 401) with the individual 101 in an attempt to determine whether the individual 101 will be a private pay patient or whether the individual 101 will be applying for government assistance (e.g., Medicaid). During the consultation, the facility representative preferably inquires as to the types and amounts of the individual's assets that may be available to pay for services which are expected to be provided by the facility 103. If the available assets are clearly going to be inadequate to compensate the facility 103 for its anticipated services given the needs of the individual 101, the facility representative preferably advises the individual 101 as to the particular requirements for obtaining government assistance to fund the living expenses of the individual 101 at the assisted living facility 103. Under most circumstances, such requirements include divestment of all or a substantial portion of the liquid and liquidatable assets of the individual 101.

One such liquidatable asset is a life insurance policy owned by the individual 101, whether such policy insures the life of the individual 101 or the life of some other person for whom the individual 101 has an insurable interest. Some states require any person seeking use of Medicaid funds to divest themselves of all life insurance, except for a policy having a face value of no more than $1,500.00. Therefore, as part of the initial consultation between the facility representative and the individual 101, the facility representative preferably inquires as to whether the individual 101 owns any life insurance policies, particularly when the individual 101 is presently, or is anticipated to be, in need of government assistance.

In the event that the assets of the individual 101 include at least one life insurance policy, the facility representative advises (203) the individual 101 as to the availability of potentially selling the individual's life insurance policy. Having received such advice and other information from the facility representative, the individual 101 then determines (403) whether to sell (e.g., viate) the individual's life insurance policy. If the individual 101 elects to sell his or her life insurance policy, the facility representative receives (205) such election from the individual 101 and preferably advises (207) the individual 101 as to the identity of (e.g., refers the individual 101 to) a potential purchaser 105 or, when the assisted living facility 103 itself serves as a potential purchaser 105 (if so permitted under applicable law), so informs the individual 101 as to the facility's purchase conditions. Alternatively, the assisted living facility 103 may serve as a broker or representative for one or more potential purchasers 105 (if so permitted under applicable law). The individual 101 may elect to sell the life insurance policy for a variety of reasons, including the individual's own desire to be a private pay patient; however, in the preferred embodiment, sale of the life insurance policy is elected by the individual 101 based on consultation with the assisted facility representative for purposes of divesting the individual's liquidatable assets to enable the individual 101 to eventually qualify for governmental funding assistance (e.g., Medicaid).

After deciding to proceed with the sale of his or her life insurance policy, the individual 101 preferably provides (405) information relating to the life insurance policy (e.g., policy number, insurer, and copy of the policy), information relating to any medical or physical condition of the insured, and any other information necessary for the potential purchaser 105 to evaluate the viability of selling the individual's life insurance policy to either the potential purchaser 105 or the assisted living facility 103. In the preferred embodiment, the medical-related information supplied by the individual 101 includes any medical records possessed by the individual 101 relating to the insured, an executed medical release from the insured (who may or may not be the individual 101 seeking admission to the assisted living facility 103), and the identities of doctors, hospitals and other care providers that have or may have medical records for the insured to thereby enable the potential purchaser 105 or its representative to obtain such medical records. The information relating to the individual's life insurance policy, the information relating to the medical information of the insured, and any other necessary information is received (211) by the facility representative (e.g., when the assisted living facility 103 acts as any form of conduit between the individual 101 and the potential purchaser 105), or is received (301) by the potential purchaser 105 directly from the individual 101 and/or the insured. When the assisted living facility 103 serves as a conduit (e.g., as representative, broker, or agent for the potential purchaser 105 (if so permitted under applicable law), simply as a courtesy to the individual 101, or otherwise) between the individual 101 and the potential purchaser 105, the assisted living facility 103 provides (213) the information received from the individual 101 and/or the insured to the potential purchaser 105 preferably after receiving written authorization to do so from the individual 101 and/or the insured, as applicable.

After the potential purchaser 105 has received all the necessary information from the individual 101 and/or the insured, the purchaser 105 determines (303) whether to purchase the life insurance policy based on the received information (e.g., when the purchaser is a viatical settlement provider, such provider determines whether viatical settlement of the life insurance policy is available based on the received information). Such a determination preferably comprises evaluating the present condition of the life insurance policy (e.g., face value amount, amount of outstanding loans and past or presently due premiums, contestability of the policy, whether or not the policy has lapsed or been reinstated at any time in its recent history), determining a life expectancy of the person insured by the life insurance policy based on the received medical information, and evaluating the likelihood of locating an investor 107 that would agree to pay a percentage of the face value of the policy, less any outstanding loans and past or presently due premiums, and continue paying the premiums on the life insurance policy. Life expectancy of the insured is preferably computed using conventional actuarial algorithms and tables that take into account the particular medical and/or physical condition of the insured, but may alternatively be computed using any available methodologies. Since life expectancies are commonly computed in the insurance industry, no further details will be provided herein with respect to computing a life expectancy of the insured except to facilitate a better understanding of the invention.

If, after completing its analysis, the potential purchaser 105 decides (303) not to purchase the individual's life insurance policy, the purchaser 105 notifies (305) the individual 101 either directly or indirectly (e.g., through the assisted living facility 103). On the other hand, if the potential purchaser 105 decides (303) to purchase (e.g., through viatical settlement or as otherwise permitted under applicable law) the individual's life insurance policy, the purchaser 105 provides (307) a purchase offer (e.g., a viatical settlement offer in the case of viatical settlement) to the individual 101, either directly or indirectly. The purchase offer preferably includes a financial portion and may also include a non-financial portion. The financial portion of the purchase offer is preferably a percentage of the face value of the life insurance policy, less any outstanding premiums due on and loans secured by the life insurance policy. The non-financial portion of the purchase offer, if included, preferably comprises, by way of example only, a fully paid-up life insurance policy having a face value of one thousand five hundred dollars ($1,500.00), the maximum value permitted under Medicaid regulations. Such a life insurance policy would assist the survivors of the individual 101 in paying the funeral expenses of the individual 101 in the event that the individual 101 dies after exhaustion of all or substantially all the individual's assets, including any sales proceeds received as a result of selling the individual's life insurance policy.

With respect to the financial portion of the purchase offer, percentage of the face value offered by the purchaser 105 may be fixed by state law or may be completely unregulated. In the preferred embodiment, the percentage offered by the potential purchaser 105 complies with the National Association of Insurance Commissioners (NAIC) Viatical Settlements Model Regulations. As a result, the percentage offered, less any outstanding premiums due on and loans secured by the life insurance policy, is eighty percent (80%) when the life expectancy of the insured is less than six (6) months, seventy percent (70%) when the life expectancy of the insured is at least six (6) months, but less than twelve (12) months, sixty-five percent (65%) when the life expectancy of the insured is at least twelve (12) months, but less than eighteen (18) months, and sixty percent (60%) when the life expectancy of the insured is at least eighteen (18) months, but less than twenty four (24) months. In addition, any such offer would preferably be greater than or equal to the cash surrender value or the accelerated death benefit of the life insurance policy. If the life expectancy of the insured is at least twenty-four (24) months, the percentage offered is preferably any percentage that is greater than or equal to the cash surrender value or the accelerated death benefit of the life insurance policy.

To illustrate the preferred settlement offer versus life expectancy relationship, assume that the individual 101 is the insured and has a life insurance policy with a face value of forty thousand dollars ($40,000.00), with no loans received or outstanding premiums owed. Also assume that all applicable requirements of the policy have been met. Further, assume that the individual 101 has been given a life expectancy, for various health reasons, of eleven (11) months. Under these circumstances, the purchaser 105 would offer (307, 407) the individual 101 seventy percent (70%) of the face value, or twenty-eight thousand dollars ($28,000), for the policy. This offered amount would also preferably be (and may have to be, if so required by state law) greater than any cash value or accelerated death benefit provided by or permitted under the policy. Based on this example, the proceeds received from the purchaser 105 could potentially provide private payment for the individual's assisted living expenses for several months, thereby deferring the individual's dependence upon government assistance.

After the purchase offer is made, the individual 101 receives (407) the offer and determines whether to accept it. If the individual 101 accepts the offer, he or she notifies (309,4 09) the purchaser 105, directly or indirectly, of the acceptance. Thereafter, the purchaser 105 receives (311) proceeds from the investor(s) 107 to satisfy the offer and coordinates (313) a transfer or change of ownership of the life insurance policy from the individual 101 to the investor(s) 107. The individual assists (411) the purchaser 105 in effecting the change of ownership of the life insurance policy to the investors(s) 107. For example, the individual 101 preferably executes an assignment and/or other documentation as required under the life insurance policy to effect the change in ownership. Since the investor(s) 107 may desire to remain anonymous with respect to the individual 101, the individual 101 preferably assigns the policy to the purchaser 105, which in turn assigns the policy to the investor(s) 107. After the change in ownership of the life insurance policy has been effected, the purchaser 105 provides (315) the proceeds to the individual 101 either directly or, more preferably, indirectly (as discussed in detail below) pursuant to the terms of the accepted offer.

The individual 101 receives (413) the sales proceeds either directly, or more preferably, indirectly, and uses (415) some or all of the proceeds to at least partially pay for the assisted living services provided by the assisted living facility 103. As a result, the assisted living facility 103 preferably receives (209) payment for at least some of the services provided to the individual 101 out of the insurance policy sales proceeds.

In the preferred embodiment, the purchaser 105 provides (315) the sales proceeds to the individual 101 indirectly through the escrow agent 109 and the trust 111. Upon receiving the proceeds from the investor(s) 107, the purchaser 105 deposits the proceeds into an escrow account of the escrow agent 109. The escrow agent 109 is also provided with release instructions for disbursing the proceeds after the individual 101 has transferred ownership of the life insurance policy to the purchaser 105 or the insured(s) 107. The release instructions are preferably set forth in the accepted purchaser offer or another agreement between the purchaser 105 and the individual 101 with respect to selling the individual's life insurance policy. The release instructions preferably require the escrow agent 109 to deposit the settlement proceeds into the trust 111 for the benefit of the individual 101. The trust 111, which also preferably constitutes part of the accepted purchase offer or other agreement entered into between the purchaser 105 and the individual 101 with respect to selling the individual's life insurance policy, is preferably arranged to require the trustee thereof to distribute the proceeds to the assisted living facility 103 to at least partially find the individual's living expenses (including medical and other healthcare-related expenses) while the individual 101 resides at the assisted living facility 103. The trust 111 is further preferably arranged to require the trustee to distribute any remaining proceeds of the trust 111 first to pay funeral expenses of the individual 101 and then, if any proceeds remain, to one or more heirs of the individual 101 in the event that the individual 101 dies prior to exhaustion of the proceeds.

Therefore, based on the preferred recitations of the escrow release conditions and the trust 111, the escrow agent 109 deposits the proceeds received from the purchaser 105 or the investor(s) 107 into an escrow account with the escrow agent 109. After receiving verification that the individual 101 has transferred ownership of the life insurance policy to either the purchaser 105 or the investor(s) 107 as provided for in the accepted purchase offer, the escrow agent 109 disburses the escrowed proceeds to the trust 111. The trust 111, or a trustee thereof, receives (501) the funds from the escrow agent 109 and, therefore, indirectly from the purchaser 105. After receiving the sales proceeds from the escrow agent 109, the trustee of the trust 111 disburses (503) the proceeds to the assisted living facility 103 over time to pay for or fund the assisted living expenses incurred by the individual 101 while resident at the assisted living facility 103. The payments may be responsive to invoices received from the assisted living facility 103 either directly or indirectly through the individual 101. So long as the individual 101 has not died (505) and funds remain (507) in the trust 111, the trustee continues to disburse (503) the funds to the assisted living facility 103 to pay for the services provided to the individual 101. If the finds are exhausted prior to the individual's death, then the individual 101 preferably applies for governmental assistance so long as the individual 101 otherwise meets any applicable assistance requirements (e.g., adequate divestment of assets). However, in the event that the individual dies (505) prior to exhaustion of the funds in the trust 111, the trustee preferably disburses (509) the funds to pay for the funeral expenses of the individual 101 and, if any funds still remain after such payment, disburses (509) the remaining funds to one or more heirs of the individual 101 pursuant to the terms of the trust 111.

In an alternative embodiment, the release conditions may require the escrow agent 109 to release the sales proceeds directly to the individual 101, or the purchaser 105 may provide the sales proceeds either directly to the trust 111, when established to insure use of the proceeds for payment of the individual's assisted living expenses, or directly to the individual 101. Still further, the accepted purchase offer may require the individual 101 to deposit the sales proceeds received from the purchaser 105 or the escrow agent 109 into the trust 1 1 1 to insure use of such proceeds to fund the individual's assisted living expenses. Still, further the accepted purchase offer may simply require the purchaser 105 to act as trustee and disburse the sales proceeds to the assisted living facility 103 over time to pay for the individual's assisted living expenses. In FIG. 1, solid lines are used to indicate the preferred flow of services, money ($), information, and documentation between the individual 101, the assisted living facility 103, the purchaser 105, the investor(s) 107, the escrow agent 109, and the trust 111 in accordance with the present invention. The dashed lines in FIG. 1 are used to indicate exemplary, but not exhaustive, alternative flows and embodiments.

The present invention encompasses a method for increasing the liquid assets of an individual primarily for the purposes of funding, or at least partially funding, the individual's living expenses while resident at an assisted living facility. With this invention, life insurance is liquidated through sale (e.g., through use of a viatical settlement procedure) to increase the individual's independent ability to pay for at least some of the assisted living expenses of the individual, thereby delaying the individual's reliance and dependence upon government assistance. By delaying an individual's reliance upon government funding for assisted living expenses, government budgets can reduce amounts allocated for healthcare and can use such resources for other purposes or to decrease taxes. In addition, by using his or her own funds to pay assisted living expenses, the individual's own morale may be improved through knowledge that he or she is not simply a ward of the government.

In the foregoing specification, the present invention has been described with reference to specific embodiments. However, one of ordinary skill in the art will appreciate that various modifications and changes may be made without departing from the spirit and scope of the present invention as set forth in the appended claims. Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions to become more pronounced are not to be construed as a critical, required, or essential feature or element of any or all the claims. As used herein and in the appended claims, the terms “comprises,” “comprising” or any other variation thereof is intended to refer to a non-exclusive inclusion, such that a process, method, apparatus, or article of manufacture that comprises a list of elements does not include only those elements in the list, but may include other elements not expressly listed or inherent to such process, method, apparatus, or article of manufacture. All terms used in the appended claims that are not otherwise specifically defined herein should be accorded their ordinary meanings.

We claim:

1. A method for increasing liquid assets available to an individual to at least partially fund living expenses of the individual at an assisted living facility, the method comprising:
consulting with the individual to identify assets of the individual that are available to pay for services which are expected to be provided to the individual at the assisted living facility;
in the event that the assets include a life insurance policy owned by the individual, advising the individual as to availability of selling the life insurance policy; and
in the event that the individual elects to sell the life insurance policy, advising the individual as to an identity of a potential purchaser of the life insurance policy.

2. The method of claim 1, wherein the step of consulting further comprises:
advising the individual as to requirements for obtaining government assistance to fund the living expenses of the individual, the requirements including divestment of a substantial portion of liquidatable assets of the individual.

3. The method of claim 2, further comprising:
receiving, from the individual, an election to sell the life insurance policy for purposes of divesting of liquidatable assets of the individual and thereafter qualifying for governmental finding assistance.

4. The method of claim 1, further comprising:
receiving, from the individual, an election to sell the life insurance policy.

5. The method of claim 1, further comprising:
receiving payment for services provided to the individual by the assisted living facility, the payment including at least a portion of proceeds received by the individual as a result of a sale of the life insurance policy.

6. The method of claim 1, further comprising:
receiving information related to the life insurance policy from the individual; and
providing the information to the potential purchaser.

7. The method of claim 1, further comprising:
receiving a medical release from the individual; and
providing the medical release to the potential purchaser.

8. The method of claim 1, wherein the life insurance policy insures a life of the individual.

9. The method of claim 1, wherein the life insurance policy insures a life of a person other than the individual.

10. A method for increasing liquid assets available to an individual to at least partially fund living expenses of the individual at an assisted living facility, the method comprising:
receiving first information relating to a life insurance policy owned by the individual, the first information being provided by the individual as a result of an analysis of assets of the individual that are available to pay for services which are expected to be provided to the individual at the assisted living facility;
receiving second information relating to a physical condition of a person insured by the life insurance policy;
determining whether to purchase the life insurance policy based at least on the first information and the second information; and
in the event that purchase of the life insurance policy is desired, providing a purchase offer to the individual.

11. The method of claim 10, wherein the step of receiving the second information comprises:
receiving medical information regarding the person insured by the life insurance policy.

12. The method of claim 11, wherein the step of receiving medical information comprises:
receiving a medical release executed by the person insured by the life insurance policy.

13. The method of claim 10, wherein the person insured by the life insurance policy is the individual.

14. The method of claim 10, wherein the person insured by the life insurance policy is a person other than the individual.

15. The method of claim 10, wherein the step of determining whether to purchase the life insurance policy comprises:
determining a life expectancy of the person insured by the life insurance policy based at least on the first information and the second information.

16. The method of claim 15, wherein the step of providing a purchase offer to the individual comprises:
offering the individual a predetermined percentage of a face value of the life insurance policy based on the life expectancy of the person insured by the life insurance policy, less any outstanding premiums due on the life insurance policy and any outstanding loans secured by the life insurance policy, in the event that the life expectancy of the person insured by the life insurance policy is less than twenty-four months.

17. The method of claim 16, wherein the predetermined percentage comprises at least eighty percent of the face value of the life insurance policy in the event that the life expectancy of the person insured by the life insurance policy is less than six months.

18. The method of claim 16, wherein the predetermined percentage comprises at least seventy percent of the face value of the life insurance policy in the event that the life expectancy of the person insured by the life insurance policy is greater than or equal to six months, but less than twelve months.

19. The method of claim 16, wherein the predetermined percentage comprises at least sixty-five percent of the face value of the life insurance policy in the event that the life expectancy of the person insured by the life insurance policy is greater than or equal to twelve months, but less than eighteen months.

20. The method of claim 16, wherein the predetermined percentage comprises at least sixty percent of the face value of the life insurance policy in the event that the life expectancy of the person insured by the life insurance policy is greater than or equal to eighteen months, but less than twenty-four months.

21. The method of claim 16, wherein the predetermined percentage is set by state law.

22. The method of claim 15, wherein the step of providing a purchase offer to the individual comprises:
offering the individual a percentage of a face value of the life insurance policy based on the life expectancy of the person insured by the life insurance policy, less any outstanding premiums due on the life insurance policy and any outstanding loans secured by the life insurance policy, in the event that the life expectancy of the person insured by the life insurance policy is greater than or equal to twenty-four months, wherein the percentage of the face value is greater than or equal to a cash surrender value or an accelerated death benefit of the life insurance policy.

23. The method of claim 10, further comprising:
receiving an acceptance of the purchase offer from the individual;
receiving proceeds to fund the purchase offer from at least one investor;
coordinating a change in ownership of the life insurance policy from the individual to the at least one investor; and
providing the proceeds to the individual after the change in the ownership of the life insurance policy has been effected.

24. The method of claim 23, wherein the acceptance of the purchase offer is received for purposes of divesting liquidatable assets of the individual and thereafter enabling the individual to qualify for government assistance in funding the living expenses of the individual at the assisted living facility.

25. The method of claim 23, wherein the step of providing the proceeds to the individual comprises:
providing the proceeds to an escrow agent; and
instructing the escrow agent to release the proceeds to the individual after the change in the ownership of the life insurance policy has been effected.

26. The method of claim 23, wherein the step of providing the proceeds to the individual comprises:
providing the proceeds to a trust, the trust being arranged to require a trustee of the trust to distribute the proceeds to the assisted living facility to at least partially find the living expenses of the individual while the individual resides at the assisted living facility.

27. The method of claim 26, wherein the trust is further arranged to require a trustee of the trust to distribute at least some of the proceeds for funeral expenses of the individual in the event that the individual dies prior to exhaustion of the proceeds.

28. The method of claim 26, wherein the trust is further arranged to require a trustee of the trust to distribute at least some of the proceeds to at least one heir of the individual in the event that the individual dies prior to exhaustion of the proceeds.

29. A method for an individual to increase liquid assets available to at least partially find living expenses at an assisted living facility, the method comprising:
consulting with the assisted living facility to identify assets of the individual that are available to pay for services which are expected to be provided to the individual at the assisted living facility;
in the event that the assets include a life insurance policy owned by the individual, providing first information relating to the life insurance policy and second information relating to a physical condition of a person insured by the life insurance policy to at least one of the assisted living facility and a potential purchaser; and
receiving a purchase offer from the potential purchaser in the event that the potential purchaser desires to purchase the life insurance policy based on the first information and the second information.

30. The method of claim 29, wherein the step of consulting with the assisted living facility further comprises:
receiving third information relating to requirements for obtaining government assistance to fund the living expenses of the individual, the requirements including divestment of a substantial portion of liquidatable assets of the individual; and
electing to proceed with sale of the life insurance policy for purposes of divesting liquidatable assets of the individual and thereafter qualifying for governmental funding assistance.

31. The method of claim 29, wherein the step of providing second information to at least one of the assisted living facility and a potential purchaser comprises providing an executed medical release to at least one of the assisted living facility and the potential purchaser.

32. The method of claim 29, further comprising:
receiving notification from at least one of the assisted living facility and the potential purchaser in the event that potential purchaser decides not to purchase the life insurance policy.

33. The method of claim 29, further comprising:
accepting the purchase offer to produce an accepted offer;
assisting the potential purchaser in effecting a change of ownership of the life insurance policy; and
receiving proceeds from the potential purchaser pursuant to terms of the accepted offer after the change of ownership of the life insurance policy has been effected.

34. The method of claim 33, wherein the step of receiving proceeds from the potential purchaser comprises:
receiving proceeds from a mutually agreed upon escrow agent pursuant to the terms of the accepted offer after the change of ownership of the life insurance policy has been effected, the escrow agent obtaining the proceeds from the potential purchaser.

35. The method of claim 33, further comprising:
using at least some of the proceeds to pay for services provided by the assisted living facility.

36. A method for managing liquid assets of an individual to at least partially fund living expenses of the individual at an assisted living facility, the method comprising:
receiving funds from at least one of the individual and a purchaser, the funds resulting from proceeds of a sale of a life insurance policy owned by the individual; and
disbursing at least some of the funds over time to the assisted living facility to at least partially fund the living expenses of the individual at the assisted living facility.

37. The method of claim 36, further comprising:
in the event that the individual dies prior to exhaustion of the funds, disbursing at least some of the funds to at least partially pay for funeral expenses of the individual.

38. The method of claim 36, further comprising:
in the event that the individual dies prior to exhaustion of the funds, disbursing at least some of the funds to at least one heir of the individual.

39. The method of claim 36, wherein the step of disbursing comprises:
disbursing at least some of the funds over time to the assisted living facility pursuant to terms of a trust to at least partially fund the living expenses of the individual at the assisted living facility.

40. A method for increasing liquid assets available to an individual to at least partially fund living expenses of the individual at an assisted living facility, the method comprising:
providing, by the assisted living facility, consultation to the individual to identify liquidatable assets of the individual that are available to pay for services which are expected to be provided to the individual at the assisted living facility and to advise the individual as to requirements for obtaining government assistance to fund the living expenses of the individual, the requirements including divestment of a substantial portion of the liquidatable assets of the individual;
in the event that the liquidatable assets of the individual include a life insurance policy owned by the individual, advising, by the assisted living facility, the individual as to availability of viatical settlement of the life insurance policy;
in the event that the individual elects to proceed with viatical settlement of the life insurance policy for purposes of divesting of liquidatable assets of the individual and thereafter qualifying for governmental funding assistance, providing, by the individual to the viatical settlement provider, at least first information relating to the life insurance policy and second information relating to a physical condition of a person insured by the life insurance policy;
determining, by the viatical settlement provider, whether viatical settlement of the life insurance policy is available based at least on the first information and the second information; and
in the event that viatical settlement of the life insurance policy is available, providing, by the viatical settlement provider, a viatical settlement offer to the individual.
